(19) United States
(12) Patent Application Publication
(10) Pub. No.: US 2007/0030595 A1
(43) Pub. Date: Feb. 8, 2007

(54) Abnormal state determination method and apparatus

(76) Inventor: Yozo Tsukamoto, Ibaraki (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/499,456

(22) Filed: Aug. 4, 2006

(30) Foreign Application Priority Data
Aug. 8, 2005 (JP) 229437/2005

(51) Int. Cl. G11B 5/82

(52) U.S. Cl. 360/135

(57) ABSTRACT

In an abnormal state determination method, the state of a first contact that is set to be open normally and closed in an operation is detected. The state of a second contact that is set to be closed normally and open in the operation complementarily to the first contact is detected. The detected states of the first and second contacts are compared, and abnormality is determined when the first and second contacts are in the same state. An abnormal state determination apparatus is also disclosed.

### BACKGROUND OF THE INVENTION

The present invention relates to an abnormal state determination method and apparatus which determine abnormality in, e.g., a printing press.

Conventionally, a printing press uses a relay in, e.g., a safety stop circuit. The relay has a first contact (normally open contact (A contact)) that is normally open and is closed upon driving and a second contact (normally closed contact (B contact)) that is closed when the first contact is open and opened when the first contact is closed, as described in, e.g., Japanese Patent Laid-Open No. 4-85041. The A contact and B contact operate in directions reverse to each other, i.e., complementarily.

In the conventional printing press, however, if one of the contacts of the relay provided in, e.g., the safety stop circuit is broken, it is difficult to detect the abnormality of the contact and specify the position of the contact. For this reason, since it takes time to repair the abnormal portion, the operating ratio of the printing press lowers, and burden for the operator increases.

### SUMMARY OF THE INVENTION

The present invention has been made to solve these problems, and has as its object to provide an abnormal state determination method and apparatus capable of detecting abnormality of contacts that operate complementarily and specifying the position of the contact.

In order to achieve the above object, according to an aspect of the present invention, there is provided an abnormal state determination method comprising the steps of detecting a state of a first contact that is set to be open normally and closed in an operation, detecting a state of a second contact that is set to be closed normally and open in the operation complementarily to the first contact, and comparing the detected state of the first contact with the detected state of the second contact and determining abnormality when the first contact and the second contact are in the same state.

According to another aspect of the present invention, there is provided an abnormal state determination apparatus comprising first state detection means for detecting a state of a first contact that is set to be open normally and closed in an operation, second state detection means for detecting a state of a second contact that is set to be closed normally and open in the operation complementarily to the first contact, and first abnormality determination means for comparing, on the basis of detection results of the first state detection means and the second state detection means, the state of the first contact with the state of the second contact and determining abnormality when the first contact and the second contact are in the same state.

### BRIEF DESCRIPTION OF THE DRAWINGS

FIG. 1 is a block diagram showing an arrangement example of a central control unit in a printing press according to an embodiment of the present invention;

FIG. 2 is a block diagram showing an arrangement example of an abnormal state detection unit (PLC control unit) in the printing press according to the embodiment of the present invention;

FIGS. 3A to 3C are flowcharts of a processing operation corresponding to an abnormal state display program executed by the CPU of the central control unit;

FIGS. 4A to 4L are flowcharts of a processing operation corresponding to an abnormal state detection program executed by the CPU of the PLC control unit; and

FIG. 5 is a functional block diagram of the CPU of the PLC control unit.

### DESCRIPTION OF THE PREFERRED EMBODIMENT

An embodiment of the present invention will be described below in detail with reference to the accompanying drawings.

A printing press according to an embodiment of the present invention includes a central control unit and an abnormal state detection unit (PLC control unit).

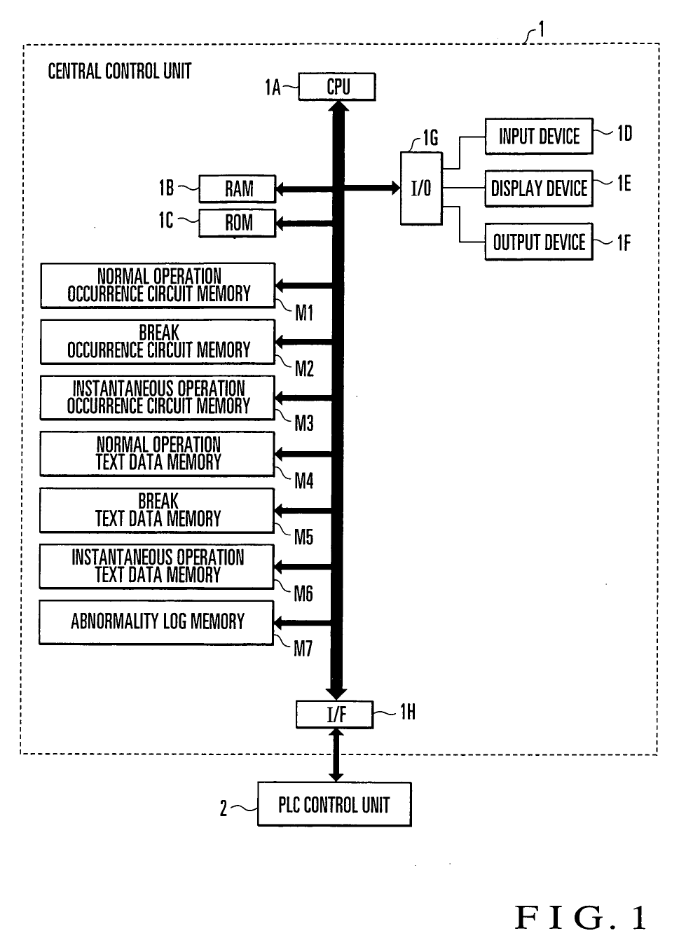

As shown in FIG. 1, a central control unit 1 comprises a CPU 1A, RAM 1B, ROM 1C, input device 1D, display device 1E, output device 1F, input/output interfaces (I/O I/Fs) 1G and 1H, and memories M1 to M7.

The CPU 1A operates in accordance with a program stored in the ROM 1C while acquiring various kinds of input information given through the interfaces 1G and 1H and accessing the RAM 1B and memories M1 to M7. The ROM 1C stores an abnormal state display program unique to this embodiment. Examples of the display device 1E are an FD drive and a printer.

The memory M1 is a normal operation occurrence circuit memory to store a safety stop circuit that normally operates. The memory M2 is a break occurrence circuit memory to store a safety stop circuit in which a break has occurred. The memory M3 is an instantaneous operation occurrence circuit memory to store a safety stop circuit in which an instantaneous operation has occurred. The memory M4 is a normal operation text data memory to store text data in case of normal operation occurrence preset for each safety stop circuit. The memory M5 is a break text data memory to store text data in case of break occurrence preset for each safety stop circuit. The memory M6 is an instantaneous operation text data memory to store text data in case of instantaneous operation occurrence preset for each safety stop circuit. The memory M7 is an abnormality log memory to store an abnormality log.

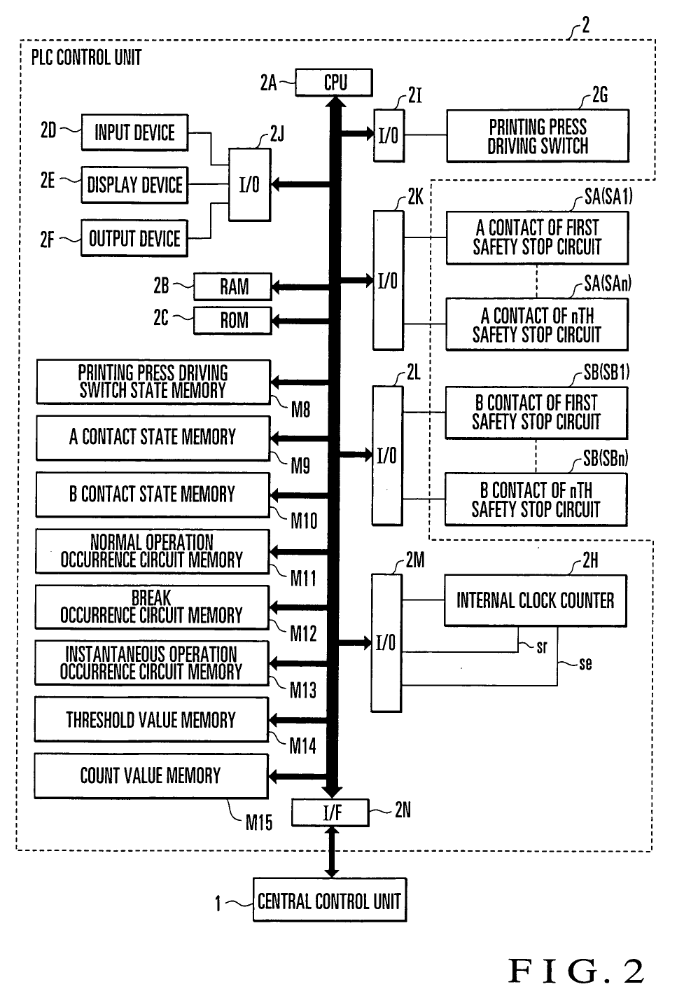

As shown in FIG. 2, a PLC control unit 2 comprises a CPU 2A, RAM 2B, ROM 2C, input device 2D, display device 2E, output device 2F, printing press driving switch 2G, internal clock counter 2H, input/output interfaces (I/O I/Fs) 2I to 2N, and memories M8 to M15. Examples of the display device 2F are an FD drive and a printer.

The input device 2D, display device 2E, and output device 2F are connected to the CPU 2A through the interface 2J. The printing press driving switch 2G is connected to the CPU 2A through the interface 2I. The internal clock counter 2H is connected to the CPU 2A through the interface 2M.

The interface 2K is provided for A contacts SA1 to SAn of the first to nth safety stop circuits in the printing press to mediate reception of the states of the A contacts SA1 to SAn by the CPU 2A. The interface 2L is provided for B contacts SB1 to SBn of the first to nth safety stop circuits in the printing press to mediate reception of the states of the B contacts SB1 to SBn by the CPU 2A.

In this embodiment, assume that each of the first to nth safety stop circuits has one relay, for the descriptive convenience. That is, in this embodiment, the A contacts SA1 to SAn of the first to nth safety stop circuits are the A contacts of the relays respectively provided in the first to nth safety stop circuits. The B contacts SB1 to SBn of the first to nth safety stop circuits are the B contacts of the same relays respectively provided in the first to nth safety stop circuits. The A contacts SA (SA1 to SAn) are set to be open normally (in a non-operating state) and closed upon relay driving (in an operating state). The B contacts SB (SB1 to SBn) are set complementarily to the A contacts SA (SA1 to SAn) to be closed when the A contacts SA are open and open when the A contacts SA are closed. In other words, the B contacts SB are set to be closed normally (in a non-operating state) and opened upon relay driving (in an operating state).

In this embodiment, the safety stop circuit operates upon recognizing certain abnormality during driving of the printing press to stop driving the printing press. In this embodiment, in the relay of the safety stop circuit, the A contact SA is open (non-operating state) while the B contact SB is closed (non-operating state) during driving of the printing press. To stop driving the printing press, the A contact SA is closed (operating state) while the B contact SB is opened (operating state) for a predetermined time. The A contact of the relay of the safety stop circuit will be referred to as the A contact of the safety stop circuit, and the B contact of the relay of the safety stop circuit will be referred to as the B contact of the safety stop circuit hereinafter.

The CPU 2A operates in accordance with a program stored in the ROM 2C while acquiring various kinds of input information given through the interfaces 2I to 2N and accessing the RAM 2B and memories M8 to M15. The ROM 2C stores an abnormal state detection program unique to this embodiment.

The memory M8 is a printing press driving switch state memory to store the state of the printing press driving switch 2G. The memory M9 is an A contact state memory to store the state of the A contact of the safety stop circuit. The memory M10 is a B contact state memory to store the state of the B contact of the safety stop circuit. The memory M11 is a normal operation occurrence circuit memory to store a safety stop circuit that normally operates. The memory M12 is a break occurrence circuit memory to store a safety stop circuit in which a break has occurred. The memory M13 is an instantaneous operation occurrence circuit memory to store a safety stop circuit in which an instantaneous operation has occurred. The memory M14 is a threshold value memory to store a preset normality/abnormality determination threshold value. The memory M15 is a count value memory to store the count value of the internal clock counter 2H.

The CPU 1A of the central control unit 1 is connected to the PLC control unit 2 through the interface 1H to transmit/receive information to/from the PLC control unit 2. The CPU 2A of the PLC control unit 2 is connected to the central control unit 1 through the interface 2N to transmit/receive information to/from the central control unit 1.

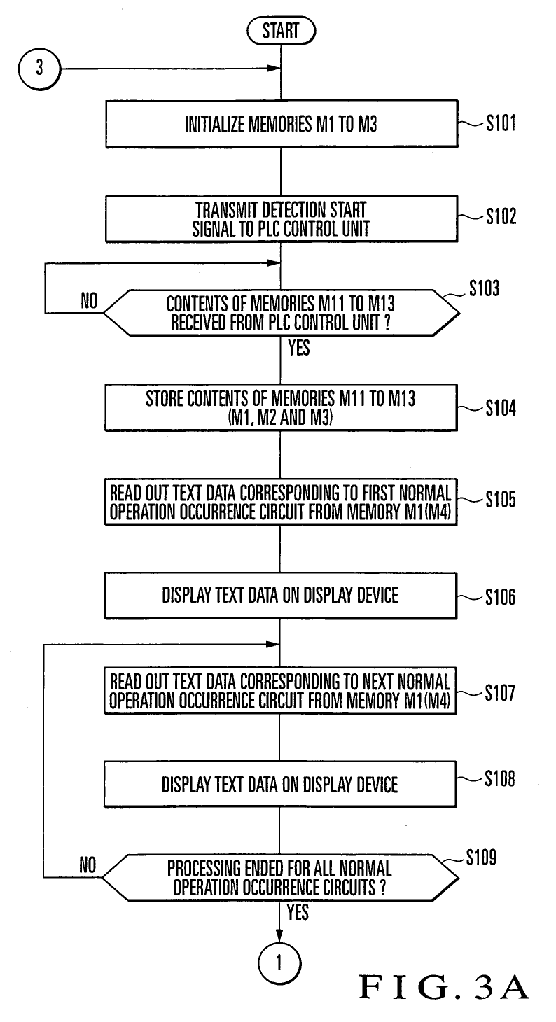

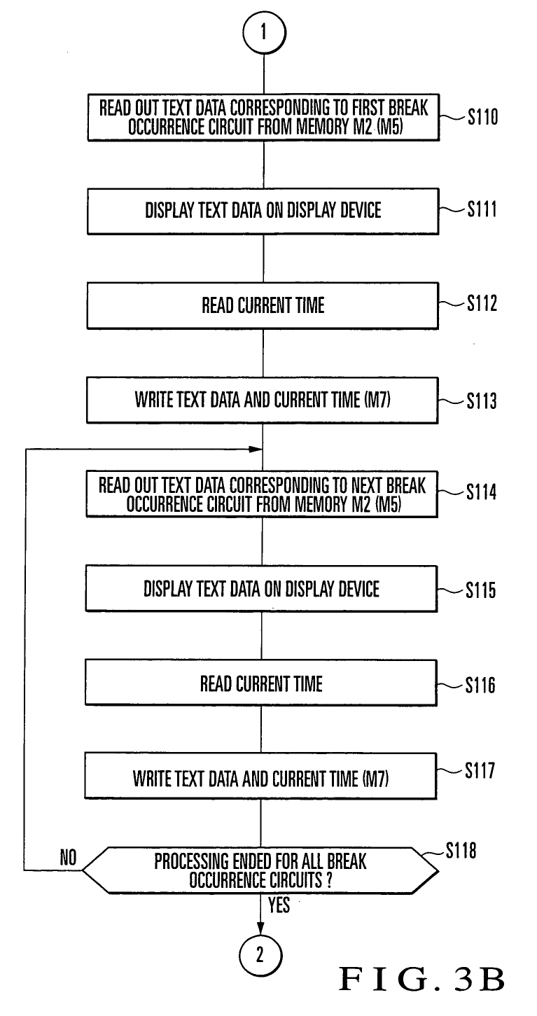

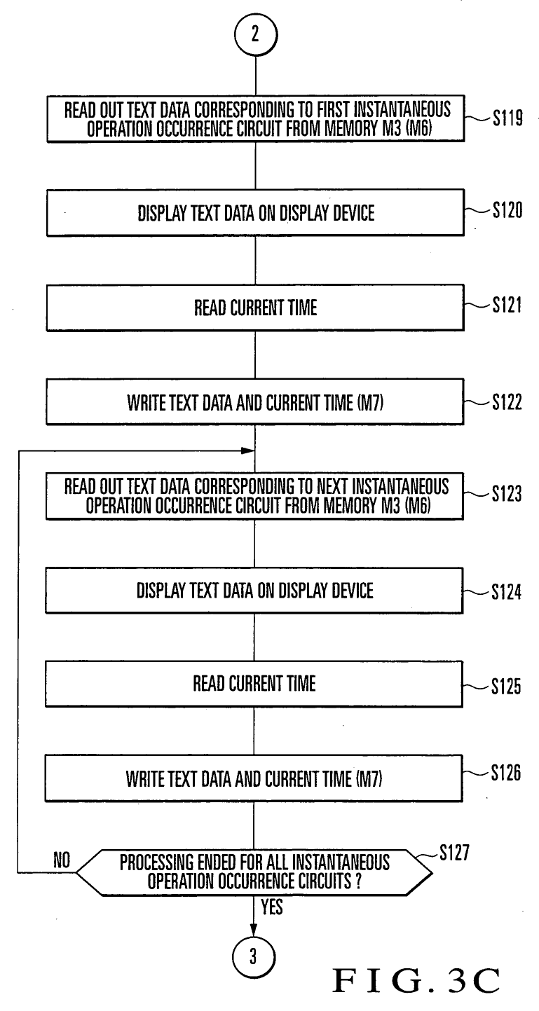

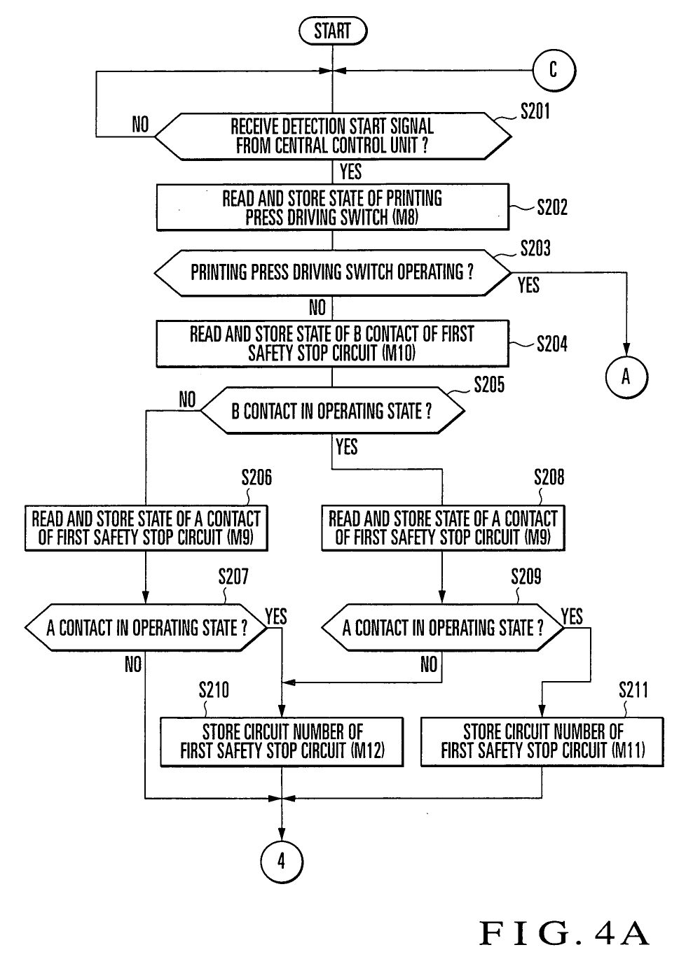

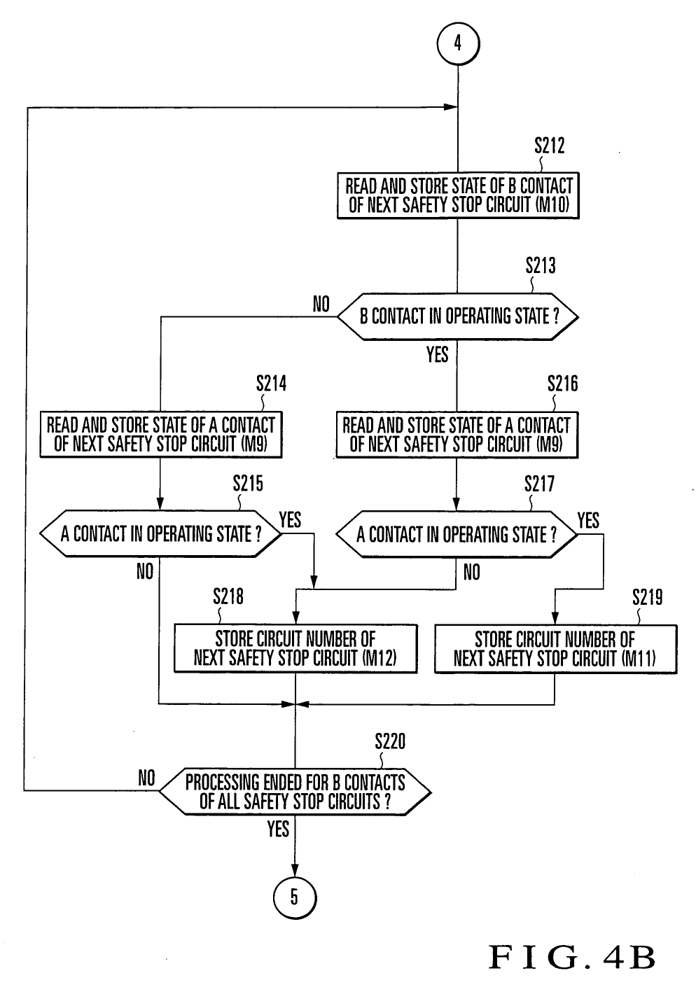

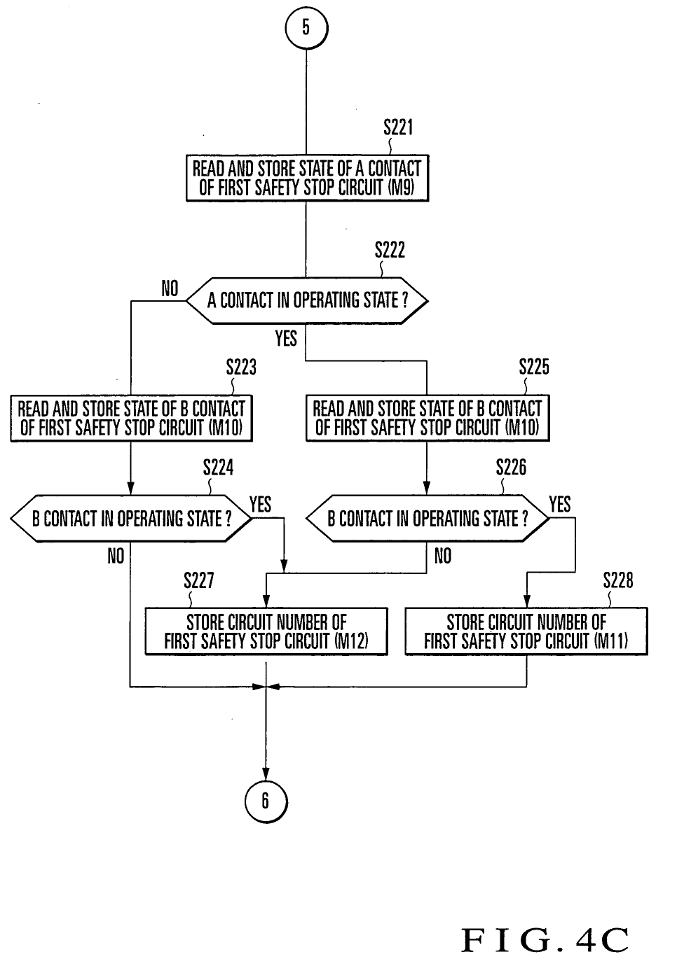

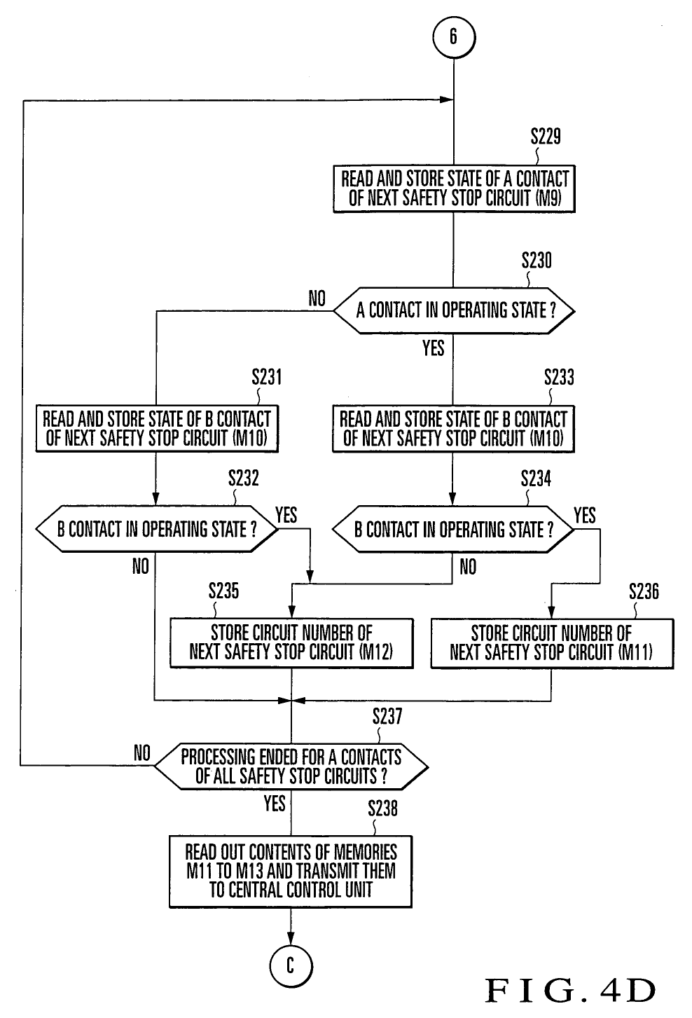

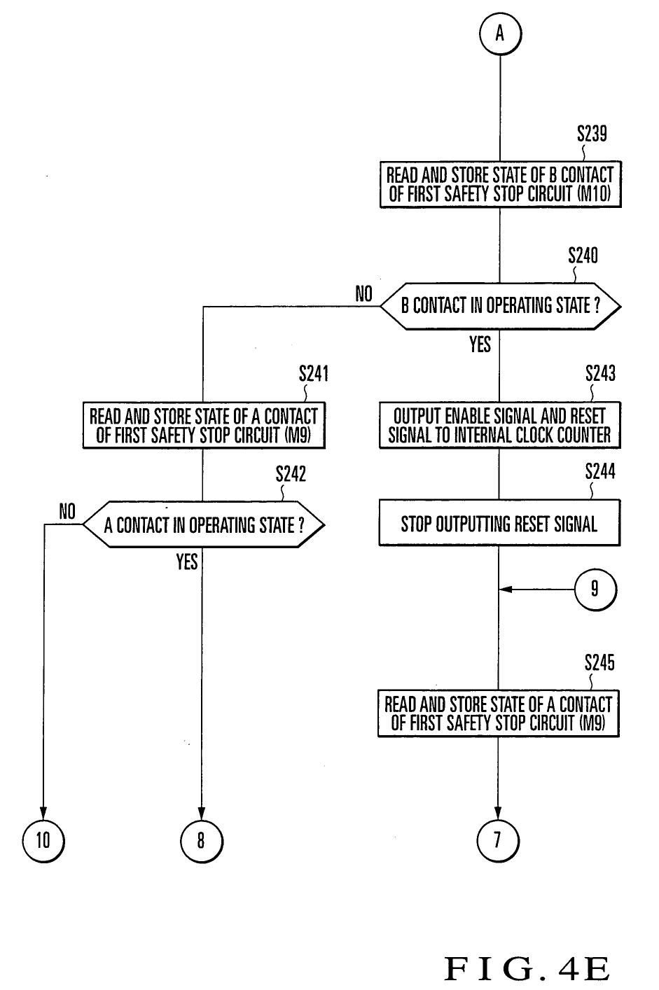

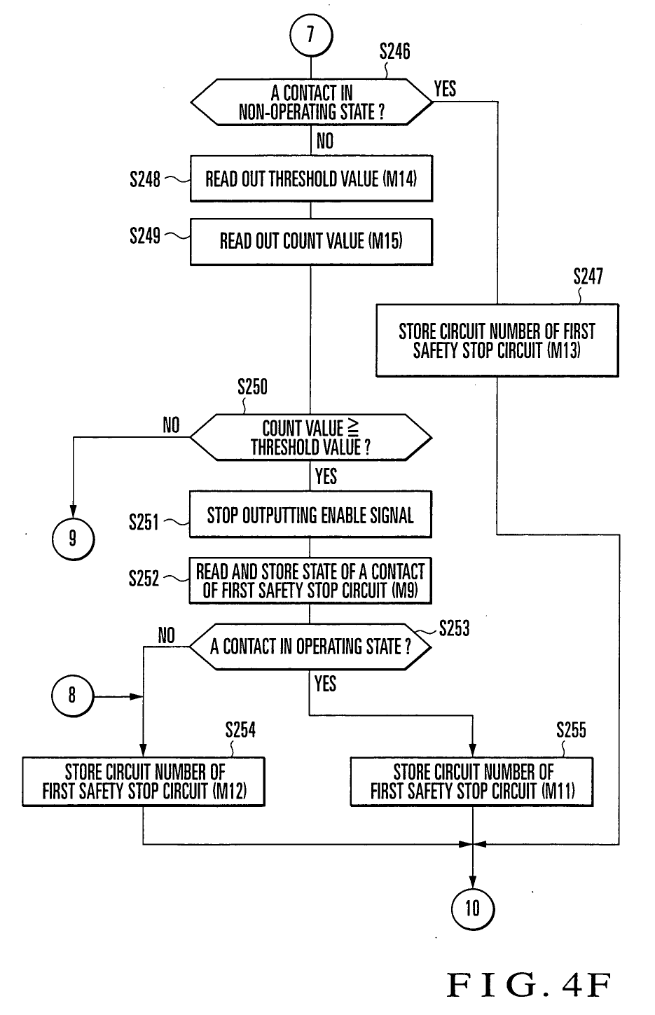

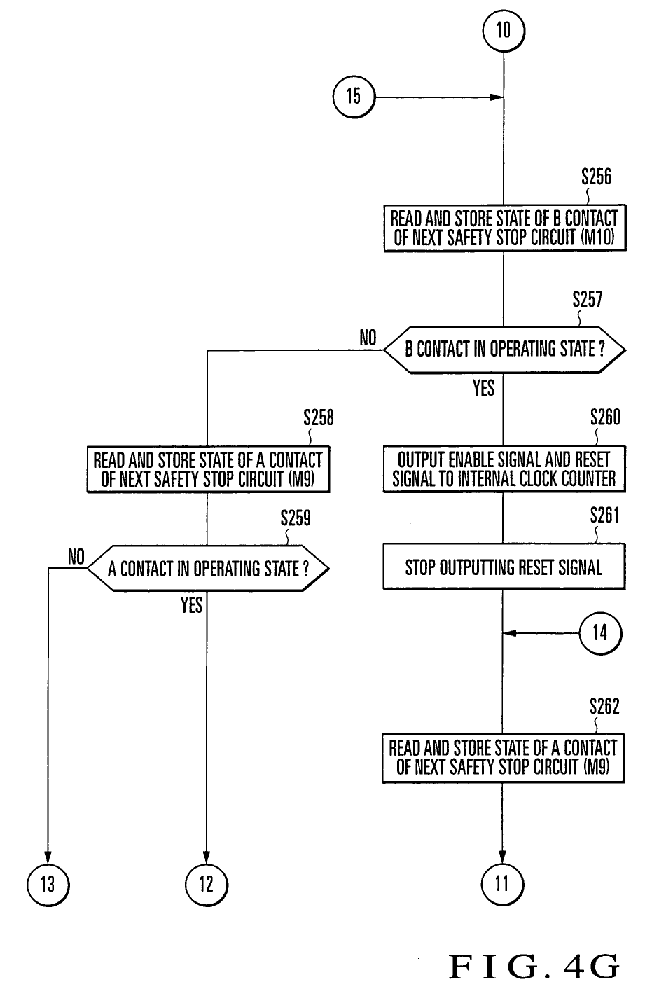

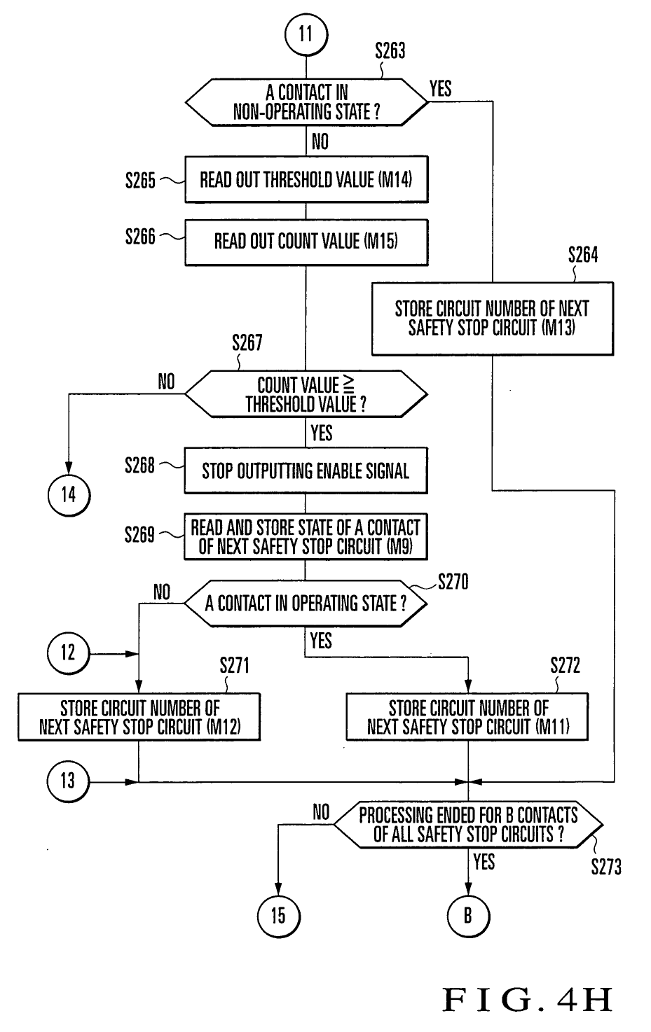

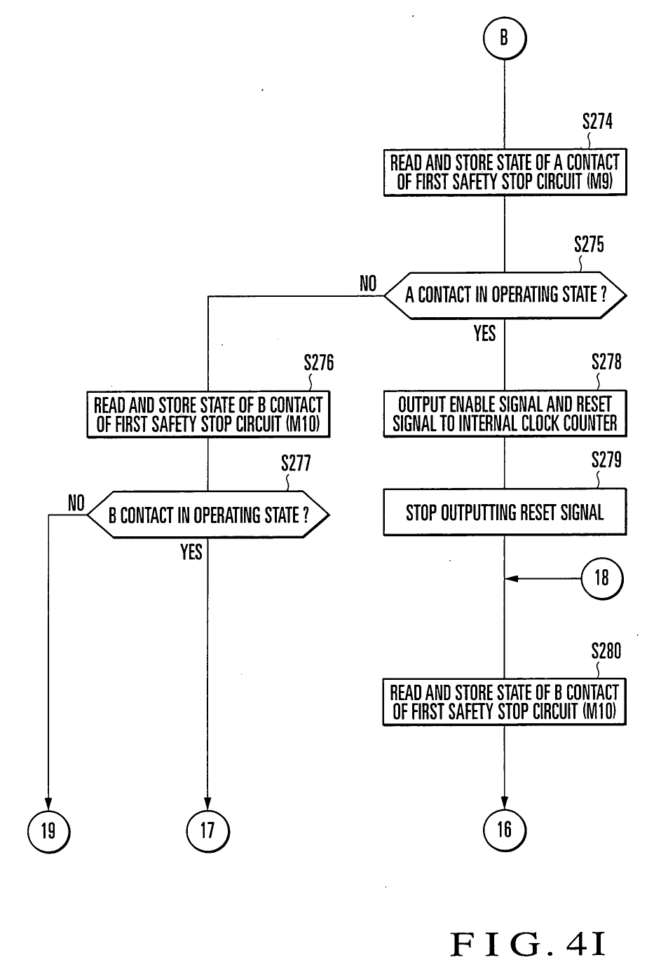

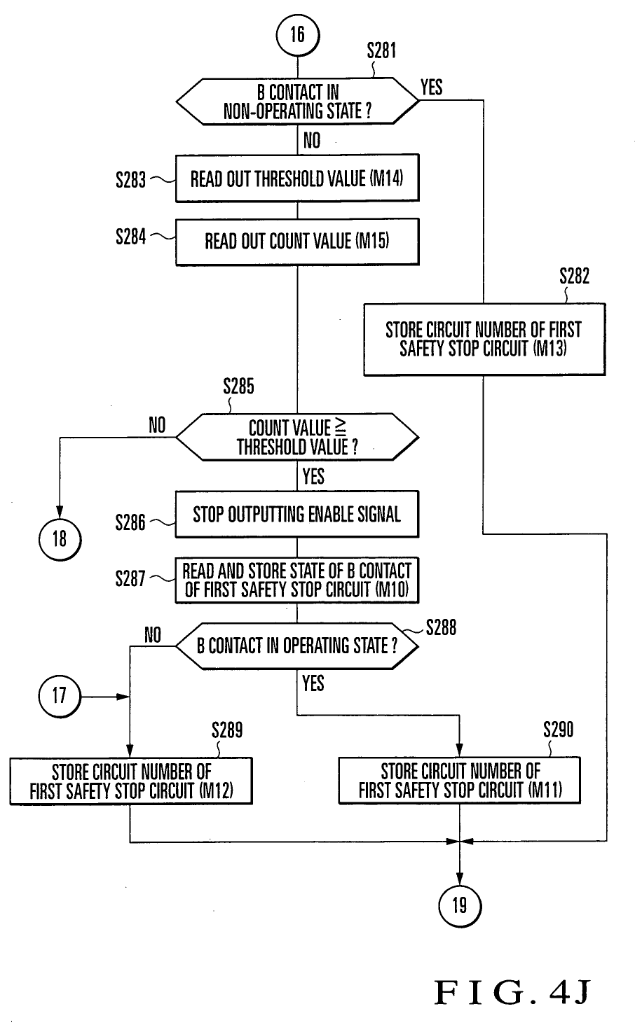

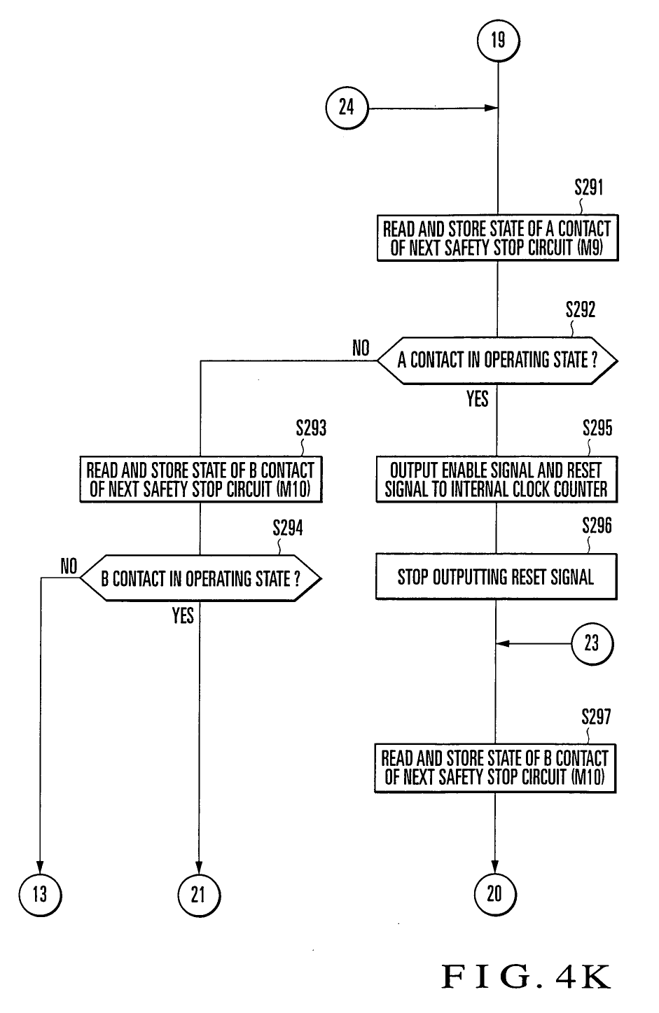

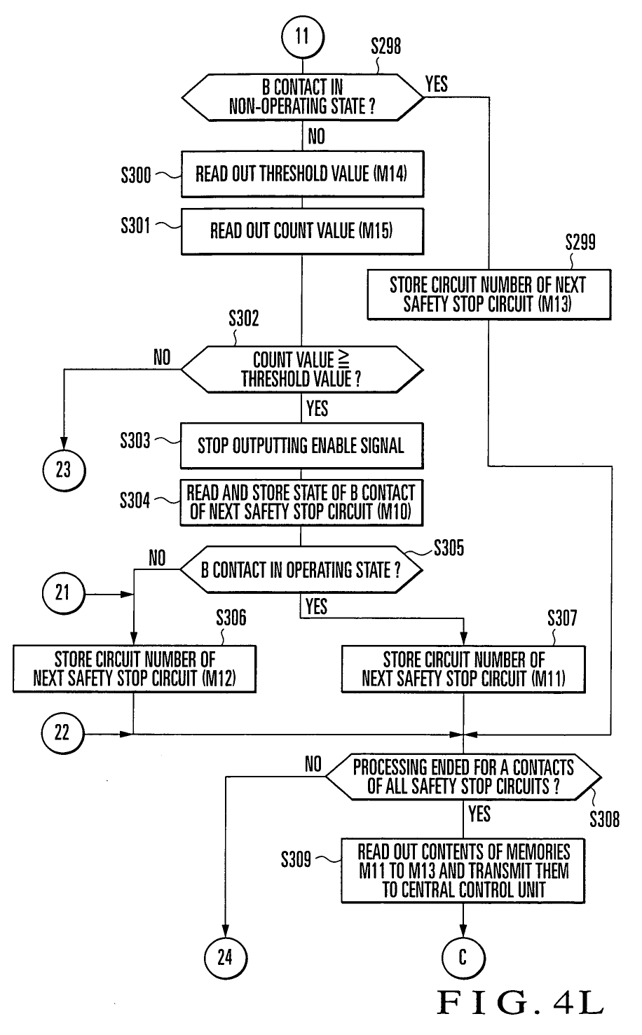

A printing press abnormal state detection/display operation according to this embodiment, which is executed by cooperation of the central control unit 1 and PLC control unit 2, will be described below with reference to the flowcharts in FIGS. 3A to 4L in association with the storage contents of the memories M1 to M15.

[Detection Start Signal Transmission from Central Control Unit]

Before the abnormal state detection/display operation, the CPU 1A of the central control unit 1 initializes the memories M1, M2, and M3 (FIG. 3A: step S101). The central control unit 1 transmits a detection start signal to the PLC control unit 2 (step S102).

[Abnormal State Detection in PLC Control Unit]

Upon receiving the detection start signal from the central control unit 1 (FIG. 4A: YES in step S201), the CPU 2A of the PLC control unit 2 reads the state of the printing press driving switch 2G and stores the state in the memory M8 (step S202). The CPU 2A checks on the basis of the state of the printing press driving switch 2G whether the printing press is being driven or at a stop (step S203).

If the printing press driving switch 2G is not operating (NO in step S203), the CPU 2A determines that the printing press is at a stop, and the flow advances to processing from step S204. If the printing press driving switch 2G is operating (YES in step S203), the CPU 2A determines that the printing press is being driven, and the flow advances to processing from step S239 (FIG. 4E).

[When Printing Press is at Stop]

[Normality/Abnormality Determination Based on State of B Contact]

Upon determining that the printing press is at a stop (NO in step S203), the CPU 2A reads the state of the B contact SB of the first safety stop circuit (i.e., first safety stop circuit) and stores the state in the memory M10 (step S204). The CPU 2A checks whether the B contact SB is in the operating state (open) or in the non-operating state (closed) (step S205).

If the B contact SB of the first safety stop circuit is in the non-operating state (closed) (NO in step S205), the state of the A contact SA of the first safety stop circuit is read and stored in the memory M9 (step S206). Then, it is checked whether the A contact SA is in the operating state (closed) or in the non-operating state (open) (step S207).

In accordance with the result, if the A contact SA is in the non-operating state (NO in step S207), the flow directly advances to step S212 (FIG. 4B). If the A contact SA is in the operating state (YES in step S207), it is determined that abnormality (break) has occurred, and the circuit number of the first safety stop circuit is written in the memory M12 as a break occurrence circuit (step S210).

If the B contact SB of the first safety stop circuit is in the operating state (open) (YES in step S205), the state of the A contact SA of the first safety stop circuit is read and stored in the memory M9 (step S208). Then, it is checked whether the A contact SA is in the operating state (closed) or in the non-operating state (open) (step S209).

In accordance with the result, if the A contact SA is in the non-operating state (NO in step S209), it is determined that abnormality (break) has occurred, and the circuit number of the first safety stop circuit is written in the memory M12 as a break occurrence circuit (step S210). If the A contact SA is in the operating state (YES in step S209), it is determined that the normal operation is being executed, and the circuit number of the first safety stop circuit is written in the memory M11 as a normal operation occurrence circuit (step S211).

[When Safety Stop Circuit is Normal: No. 1]

In this embodiment, when the printing press is at a stop, and each safety stop circuit is normal, the B contact SB is closed (non-operating state) while the A contact SA is open (non-operating state). In this case, the flow advances to step S212 via steps S205, S206, and S207.

[When Safety Stop Circuit is Normal: No. 2]

In this embodiment, when, for example, a safety cover circuit (this circuit operates to stop driving the printing press) serving one of the safety stop circuits is opened (set in the operating state) by the operator's work during the stop of the printing press, and the safety stop circuit is normal, the B contact SB is open (operating state) while the A contact SA is closed (operating state). In this case, the flow advances to step S211 via steps S205, S208, and S209 to write the circuit number of the first safety stop circuit in the memory M11 as a normal operation occurrence circuit.

To the contrary, if the B contact SB of the first safety stop circuit is in the non-operating state (closed) (NO in step S205) while the A contact SA is in the operating state (closed) (YES in step S207), i.e., if both the B contact SB and the A contact SA of the first safety stop circuit are closed, it is determined that abnormality (break) has occurred, and the circuit number of the first safety stop circuit is written in the memory M12 as a break occurrence circuit (step S210).

If the B contact SB of the first safety stop circuit is in the operating state (open) (YES in step S205) while the A contact SA is in the non-operating state (open) (NO in step S209), i.e., if both the B contact SB and the A contact SA of the first safety stop circuit are open, it is determined that abnormality (break) has occurred, and the circuit number of the first safety stop circuit is written in the memory M12 as a break occurrence circuit (step S210).

The CPU 2A executes, for the next safety stop circuit (e.g., second safety stop circuit), the same processing as in step S204 to S211 executed for the first safety stop circuit. More specifically, the state of the B contact is compared with that of the A contact. If both the B contact SB and the A contact SA of the next safety stop circuit are closed, it is determined that abnormality (break) has occurred. If both the B contact SB and the A contact SA of the next safety stop circuit are open, it is determined that abnormality (break) has occurred, and the circuit number of the next safety stop circuit is written in the memory M12 as a break occurrence circuit. If the B contact SB of the next safety stop circuit is open (operating state) while the A contact SA is closed (operating state), it is determined that the normal operation is being executed, and the circuit number of the next safety stop circuit is written in the memory M11 as a normal operation occurrence circuit (FIG. 4B: steps S212 to S219).

Similarly, the processing operation in steps S212 to S220 is repeated until the processing is ended for the B contacts of all the n safety stop circuits in step S220. With this processing, normality/abnormality of all safety stop circuits is determined on the basis of the state of the B contact. The circuit number of each break occurrence circuit is written in the memory M12, and the circuit number of each normal operation occurrence circuit is written in the memory M11.

[Normality/Abnormality Determination Based on State of a Contact]

The CPU 2A reads the state of the A contact SA of the first safety stop circuit and stores the state in the memory M9 (FIG. 4C: step S221). The CPU 2A checks whether the A contact SA is in the operating state (closed) or in the non-operating state (open) (step S222).

If the A contact SA of the first safety stop circuit is in the non-operating state (open) (NO in step S222), the state of the B contact SB of the first safety stop circuit is read and stored in the memory M10 (step S223). Then, it is checked whether the B contact SB is in the operating state (open) or in the non-operating state (closed) (step S224).

In accordance with the result, if the B contact SB is in the non-operating state (NO in step S224), the flow directly advances to step S229 (FIG. 4D). If the B contact SB is in the operating state (YES in step S224), it is determined that abnormality (break) has occurred, and the circuit number of the first safety stop circuit is written in the memory M12 as a break occurrence circuit (step S227).

If the A contact SA of the first safety stop circuit is in the operating state (closed) (YES in step S222), the state of the B contact SB of the first safety stop circuit is read and stored in the memory M10 (step S225). Then, it is checked whether the B contact SB is in the operating state (open) or in the non-operating state (closed) (step S226).

In accordance with the result, if the B contact SB is in the non-operating state (NO in step S226), it is determined that abnormality (break) has occurred, and the circuit number of the first safety stop circuit is written in the memory M12 as a break occurrence circuit (step S227). If the B contact SB is in the operating state (YES in step S226), it is determined that the normal operation is being executed, and the circuit number of the first safety stop circuit is written in the memory M11 as a normal operation occurrence circuit (step S228).

[When Safety Stop Circuit is Normal: No. 1]

In this embodiment, when the printing press is at a stop, and each safety stop circuit is normal, the A contact SA is open (non-operating state) while the B contact SB is closed (non-operating state). In this case, the flow advances to step S229 via steps S222, S223, and S224.

[When Safety Stop Circuit is Normal: No. 2]

In this embodiment, when, for example, a safety cover circuit (this circuit operates to stop driving the printing press) serving one of the safety stop circuits is opened (set in the operating state) by the operator's work during the stop of the printing press, and the safety stop circuit is normal, the A contact SA is closed (operating state) while the B contact SB is open (operating state). In this case, the flow advances to step S228 via steps S222, S225, and S226 to write the circuit number of the first safety stop circuit in the memory M11 as a normal operation occurrence circuit.

To the contrary, if the A contact SA of the first safety stop circuit is in the non-operating state (open) (NO in step S222) while the B contact SB is in the operating state (open) (YES in step S224), i.e., if both the A contact SA and the B contact SB of the first safety stop circuit are open, it is determined that abnormality (break) has occurred, and the circuit number of the first safety stop circuit is written in the memory M12 as a break occurrence circuit (step S227).

If the A contact SA of the first safety stop circuit is in the operating state (closed) (YES in step S222) while the B contact SB is in the non-operating state (closed) (NO in step S226), i.e., if both the A contact SA and the B contact SB of the first safety stop circuit are closed, it is determined that abnormality (break) has occurred, and the circuit number of the first safety stop circuit is written in the memory M12 as a break occurrence circuit (step S227).

The CPU 2A executes, for the next safety stop circuit, the same processing as in step S204 to S211 executed for the first safety stop circuit. More specifically, the state of the A contact is compared with that of the B contact. If both the A contact SA and the B contact SB of the next safety stop circuit are open, it is determined that abnormality (break) has occurred. If both the A contact SA and the B contact SB of the next safety stop circuit are closed, it is determined that abnormality (break) has occurred, and the circuit number of the next safety stop circuit is written in the memory M12 as a break occurrence circuit. If the A contact SA of the next safety stop circuit is closed (operating state) while the B contact SB is open (operating state), it is determined that the normal operation is being executed, and the circuit number of the next safety stop circuit is written in the memory M11 as a normal operation occurrence circuit (FIG. 4D: steps S229 to S236).

Similarly, the processing operation in steps S229 to S237 is repeated until the processing is ended for the A contacts of all the n safety stop circuits in step S237. With this processing, normality/abnormality of all safety stop circuits is determined on the basis of the state of the A contact. The circuit number of each break occurrence circuit is written in the memory M12, and the circuit number of each normal operation occurrence circuit is written in the memory M11.

When the processing is ended for all safety stop circuits (YES in step S237), the CPU 2A reads out the circuit numbers of normal operation occurrence circuits written in the memory M11, the circuit numbers of break occurrence circuits written in the memory M12, and the circuit numbers of the instantaneous operation occurrence circuits written in the memory M13 and transmits them to the central control unit 1 (step S238). The instantaneous operation occurrence circuit will be described later.

[When Printing Press is Being Driven]

[Normality/Abnormality Determination Based on State of B Contact]

Upon determining that the printing press is being driven (FIG. 4A: YES in step S203), the CPU 2A reads the state of the B contact SB of the first safety stop circuit and stores the state in the memory M10 (FIG. 4E: step S239). The CPU 2A checks whether the B contact SB is in the operating state (open) or in the non-operating state (closed) (step S240).

If the B contact SB of the first safety stop circuit is in the non-operating state (closed) (NO in step S240), the state of the A contact SA of the first safety stop circuit is read and stored in the memory M9 (step S241). Then, it is checked whether the A contact SA is in the operating state (closed) or in the non-operating state (open) (step S242).

In this embodiment, when the printing press is being driven, and each safety stop circuit is normal, the B contact SB is closed (non-operating state) while the A contact SA is open (non-operating state). Hence, if the first safety stop circuit is normal, the flow advances to step S256 (FIG. 4G) via steps S240, S241, and S242.

To the contrary, if the B contact SB of the first safety stop circuit is in the non-operating state (closed) (NO in step S240), and the A contact SA is in the operating state (closed) (YES in step S242), i.e., if both the B contact SB and the A contact SA of the first safety stop circuit are closed, the CPU 2A determines that abnormality (break) has occurred and writes the circuit number of the first safety stop circuit in the memory M12 as a break occurrence circuit (FIG. 4F: step S254).

If the B contact SB of the first safety stop circuit is open (operating state) (YES in step S240), the CPU 2A outputs an enable signal sₑ and a reset signal sᵣ to the internal clock counter 2H (step S243). Then, the CPU 2A stops outputting the reset signal sᵣ to the internal clock counter 2H and causes it to start the count operation (step S244). The count value of the internal clock counter 2H is stored in the memory M15. The CPU 2A reads the state of the A contact SA of the first safety stop circuit and stores the state in the memory M9 (step S245). The CPU 2A checks whether the A contact SA is in the operating state (closed) or in the non-operating state (open) (FIG. 4F: step S246).

If the B contact SB of the first safety stop circuit is open (operating state) (YES in step S240) while the A contact SA is closed (non-operating state) (NO in step S246), the CPU 2A reads out the normality/abnormality determination threshold value preset in the memory M14 (step S248) and compares it with the count value of the internal clock counter 2H (steps S249 and S250). If the count value of the internal clock counter 2H is smaller than the normality/abnormality determination threshold value (NO in step S250), the CPU 2A returns to step S245 to repeat the same operation.

If the A contact SA of the first safety stop circuit changes to the open state (non-operating state) before the count value of the internal clock counter 2H reaches the normality/abnormality determination threshold value, i.e., after the open state (operating state) of the B contact SB of the safety stop circuit is detected before a predetermined time (preset time) corresponding to the normality/abnormality determination threshold value elapses (YES in step S246), the CPU 2A determines that abnormality (instantaneous operation) has occurred and writes the circuit number of the first safety stop circuit in the memory M13 as an instantaneous operation occurrence circuit (step S247). Such an instantaneous operation of the A contact SA occurs due to, e.g., instantaneous manipulation, vibration, maladjustment, and contact failure.

If the A contact SA of the first safety stop circuit is continuously closed (operating state), and the count value of the internal clock counter 2H reaches the normality/abnormality determination threshold value (YES in step S250), i.e., if the A contact SA of the safety stop circuit is continuously closed (operating state) during a predetermined time (preset time) corresponding to the normality/abnormality determination threshold value after detection of the open state (operating state) of the B contact SB of the first safety stop circuit, the CPU 2A stops outputting the enable signal sₑ to the internal clock counter 2H to stop its operation (step S251). The CPU 2A reads the state of the A contact SA of the first safety stop circuit (step S252), confirms that the A contact SA is closed (operating state) (YES in step S253), determines that the normal operation is being executed, and writes the circuit number of the first safety stop circuit in the memory M11 as a normal operation occurrence circuit (step S255).

If the A contact SA of the first safety stop circuit is open (non-operating state) (NO in step S253), i.e., if the A contact SA of the first safety stop circuit is in the non-operating state (open) regardless of the operating state (open) of the B contact SB of the first safety stop circuit, the CPU 2A determines that abnormality (break) has occurred and writes the circuit number of the first safety stop circuit in the memory M12 as a break occurrence circuit (step S254).

The CPU 2A executes, for the next safety stop circuit, the same processing as in step S239 to S255 executed for the first safety stop circuit. More specifically, the CPU 2A measures the time after detection of the open state (operating state) of the B contact SB of the next safety stop circuit. Normality/abnormality (instantaneous operation occurrence) is determined depending on whether the A contact SA of the safety stop circuit returns to the open state (non-operating state) before the time reaches a predetermined time (preset time) corresponding to the normality/abnormality determination threshold value. In addition, normality/abnormality (break occurrence) is determined depending on whether the A contact SA of the safety stop circuit is in the non-operating state (open) although the B contact SB is in the operating state (open) and whether the A contact SA of the safety stop circuit is in the operating state (closed) although the B contact SB is in the non-operating state (closed). If it is determined that an instantaneous operation has occurred, the circuit number of the next safety stop circuit is written in the memory M13 as an instantaneous operation occurrence circuit. If it is determined that a break has occurred, the circuit number of the next safety stop circuit is written in the memory M15 as a break occurrence circuit. If it is determined that the normal operation is being executed, the circuit number of the next safety stop circuit is written in the memory M11 as a normal operation occurrence circuit (FIGS. 4G and 4H: steps S256 to S272).

Similarly, the processing operation in steps S256 to S273 is repeated until the processing is ended for the B contacts of all the n safety stop circuits in step S273. With this processing, normality/abnormality of all safety stop circuits is determined on the basis of the state of the B contact. The circuit number of each instantaneous operation occurrence circuit is written in the memory M13, the circuit number of each break occurrence circuit is written in the memory M12, and the circuit number of each normal operation occurrence circuit is written in the memory M11.

[Normality/Abnormality Determination Based on State of a Contact]

The CPU 2A reads the state of the A contact SA of the first safety stop circuit and stores the state in the memory M9 (FIG. 4I: step S274). The CPU 2A checks whether the A contact SA is in the operating state (closed) or in the non-operating state (open) (step S275).

If the A contact SA of the first safety stop circuit is in the non-operating state (open) (NO in step S275), the state of the B contact SB of the first safety stop circuit is read and stored in the memory M10 (step S276). Then, it is checked whether the B contact SB is in the operating state (open) or in the non-operating state (closed) (step S277).

In this embodiment, when the printing press is being driven, and each safety stop circuit is normal, the A contact SA is open (non-operating state) while the B contact SB is closed (non-operating state). Hence, if the first safety stop circuit is normal, the flow advances to step S291 (FIG. 4K) via steps S275, S276, and S277.

To the contrary, if the A contact SA of the first safety stop circuit is in the non-operating state (open) (NO in step S275), and the B contact SB is in the operating state (open) (YES in step S277), i.e., if both the A contact SA and the B contact SB of the first safety stop circuit are open, the CPU 2A determines that abnormality (break) has occurred and writes the circuit number of the first safety stop circuit in the memory M12 as a break occurrence circuit (FIG. 4J: step S289).

If the A contact SA of the first safety stop circuit is closed (operating state) (YES in step S275), the CPU 2A outputs the enable signal sₑ and the reset signal sᵣ to the internal clock counter 2H (step S278). Then, the CPU 2A stops outputting the reset signal sᵣ to the internal clock counter 2H and causes it to start the count operation (step S279). The count value of the internal clock counter 2H is stored in the memory M15. The CPU 2A reads the state of the B contact SB of the first safety stop circuit and stores the state in the memory M10 (step S280). The CPU 2A checks whether the B contact SB is in the operating state (open) or in the non-operating state (closed) (FIG. 4J: step S281).

If the A contact SA of the first safety stop circuit is closed (operating state) (YES in step S275) while the B contact SB is open (non-operating state) (NO in step S281), the CPU 2A reads out the normality/abnormality determination threshold value preset in the memory M14 (step S283) and compares it with the count value of the internal clock counter 2H (steps S284 and S285). If the count value of the internal clock counter 2H is smaller than the normality/abnormality determination threshold value (NO in step S285), the CPU 2A returns to step S280 to repeat the same operation.

If the B contact SB of the first safety stop circuit changes to the closed state (non-operating state) before the count value of the internal clock counter 2H reaches the normality/abnormality determination threshold value, i.e., after the closed state (operating state) of the A contact SA of the safety stop circuit is detected before a predetermined time (preset time) corresponding to the normality/abnormality determination threshold value elapses (YES in step S281), the CPU 2A determines that abnormality (instantaneous operation) has occurred and writes the circuit number of the first safety stop circuit in the memory M13 as an instantaneous operation occurrence circuit (step S282). Such an instantaneous operation of the B contact SB occurs due to, e.g., instantaneous manipulation, vibration, maladjustment, and contact failure.

If the B contact SB of the first safety stop circuit is continuously open (operating state), and the count value of the internal clock counter 2H reaches the normality/abnormality determination threshold value (YES in step S285), i.e., if the B contact SB of the safety stop circuit is continuously open (operating state) during a predetermined time (preset time) corresponding to the normality/abnormality determination threshold value after detection of the closed state (operating state) of the A contact SA of the first safety stop circuit, the CPU 2A stops outputting the enable signal se to the internal clock counter 2H to stop its operation (step S286). The CPU 2A reads the state of the B contact SB of the first safety stop circuit (step S287), confirms that the B contact SB is open (operating state) (YES in step S288), determines that the normal operation is being executed, and writes the circuit number of the first safety stop circuit in the memory M11 as a normal operation occurrence circuit (step S290).

If the B contact SB of the first safety stop circuit is closed (non-operating state) (NO in step S288), i.e., if the B contact SB of the first safety stop circuit is in the non-operating state (closed) regardless of the operating state (closed) of the A contact SA of the first safety stop circuit, the CPU 2A determines that abnormality (break) has occurred and writes the circuit number of the first safety stop circuit in the memory M12 as a break occurrence circuit (step S289).

The CPU 2A executes, for the next safety stop circuit, the same processing as in step S274 to S290 executed for the first safety stop circuit. More specifically, the CPU 2A measures the time after detection of the closed state (operating state) of the A contact SA of the next safety stop circuit. Normality/abnormality (instantaneous operation occurrence) is determined depending on whether the B contact SB of the safety stop circuit returns to the closed state (non-operating state) before the time reaches a predetermined time (preset time) corresponding to the normality/abnormality determination threshold value. In addition, normality/abnormality (break occurrence) is determined depending on whether the B contact SB of the safety stop circuit is in the non-operating state (closed) although the A contact SA is in the operating state (closed) and whether the B contact SB of the safety stop circuit is in the operating state (open) although the A contact SA is in the non-operating state (open). If it is determined that an instantaneous operation has occurred, the circuit number of the next safety stop circuit is written in the memory M13 as an instantaneous operation occurrence circuit. If it is determined that a break has occurred, the circuit number of the next safety stop circuit is written in the memory M15 as a break occurrence circuit. If it is determined that the normal operation is being executed, the circuit number of the next safety stop circuit is written in the memory M11 as a normal operation occurrence circuit (FIGS. 4K and 4L: steps S291 to S307).

Similarly, the processing operation in steps S291 to S308 is repeated until the processing is ended for the A contacts of all the n safety stop circuits in step S308. With this processing, normality/abnormality of all safety stop circuits is determined on the basis of the state of the A contact. The circuit number of each instantaneous operation occurrence circuit is written in the memory M13, the circuit number of each break occurrence circuit is written in the memory M12, and the circuit number of each normal operation occurrence circuit is written in the memory M11.

When the processing is ended for all safety stop circuits (YES in step S308), the CPU 2A reads out the circuit numbers of normal operation occurrence circuits written in the memory M11, the circuit numbers of break occurrence circuits written in the memory M12, and the circuit numbers of the instantaneous operation occurrence circuits written in the memory M13 and transmits them to the central control unit 1 (step S309).

In this abnormal state detection operation, the B contact of the safety stop circuit may already be open (operating state) at the timing of detecting the open state (operating state) of the B contact of the safety stop circuit (steps S240 and S257). In addition, the A contact of the safety stop circuit may already be closed (operating state) at the timing of detecting the closed state (operating state) of the A contact of the safety stop circuit (steps S275 and S292). However, the CPU 2A repeats the processing operation from step S239 at a high speed during driving of the printing press. For this reason, the difference between the timing when the B contact of the safety stop circuit actually changes to the open state (operating state) and the timing when the open state (operating state) is detected is small. The difference between the timing when the A contact of the safety stop circuit actually changes to the closed state (operating state) and the timing when the closed state (operating state) is detected is small. Hence, instantaneous operation occurrence can be detected without errors.

If a safety stop circuit operates during the abnormal state detection operation, the printing press stops regardless of instantaneous operation/normal operation. In this case, the printing press driving switch 2G cancels self holding and indicates the printing press stop state. Hence, when the contents of the memories M11, M12, and M13 are transmitted to the central control unit 1 in step S309, and the detection start signal is transmitted from the central control unit 1 again, the flow advances to processing from step S204 in accordance with NO in step S203. That is, when the printing press is being driven, processing from step S239 is repeated in accordance with YES in step S203. However, if at least one safety stop circuit operates, the flow advances to processing from step S204 instead of advancing to processing from step S239.

In this abnormal state detection operation, the time after detection of the open state (operating state) of the B contact of the safety stop circuit is measured. Abnormality (instantaneous operation occurrence) is determined depending on whether the A contact of the safety stop circuit returns to the open state (non-operating state) before the time reaches a predetermined time (preset time) corresponding to the normality/abnormality determination threshold value. However, abnormality (instantaneous operation occurrence) may be determined depending on whether the B contact of the safety stop circuit returns to the closed state (non-operating state) within the preset time. This also applies to a case wherein the time after detection of the closed state (operating state) of the A contact of the safety stop circuit is measured. Abnormality (instantaneous operation occurrence) may be determined depending on whether the A contact of the safety stop circuit returns to the open state (non-operating state) before the time reaches the predetermined time (preset time) corresponding to the normality/abnormality determination threshold value.

[Abnormal State Display in Central Control Unit]

The CPU 1A of the central control unit 1 receives, from the PLC control unit 2, the circuit numbers of normal operation occurrence circuits in the memory M11, the circuit numbers of break occurrence circuits in the memory M12, and the circuit numbers of instantaneous operation occurrence circuits in the memory M13 (FIG. 3A: step S103) and writes the circuit numbers of normal operation occurrence circuits in the memory M1, the circuit numbers of break occurrence circuits in the memory M2, and the circuit numbers of instantaneous operation occurrence circuits in the memory M3 (step S104).

[Display of Normal Operation Occurrence Circuits]

The CPU 1A reads out the circuit number of the first normal operation occurrence circuit from the memory M1 and reads out text data from an address in the memory M4 corresponding to the circuit number (step S105). This text data is text data for normal operation occurrence which is predetermined for the safety stop circuit serving as the first normal operation occurrence circuit. The text data may contain the position information of the corresponding safety stop circuit. The CPU 1A displays the readout text data on the display device 1E (step S106).

The CPU 1A reads out the circuit number of the next normal operation occurrence circuit from the memory M1, reads out text data from an address in the memory M4 corresponding to the circuit number (step S107), and displays the text data on the display device 1E (step S108).

Similarly, the processing operation in steps S107 to S109 is repeated until the processing is ended for all normal operation occurrence circuits in the memory M1 in step S109. With this processing, for all safety stop circuits, i.e., all normal operation occurrence circuits in the memory M1, text data for normal operation occurrence which are predetermined for the circuits are displayed on the display device 1E.

[Display of Break Occurrence Circuits and Saving of Abnormality Log]

The CPU 1A reads out the circuit number of the first break occurrence circuit from the memory M2 and reads out text data from an address in the memory M5 corresponding to the circuit number (FIG. 3B: step S110). This text data is text data for break occurrence which is predetermined for the safety stop circuit serving as the first break occurrence circuit. The text data may contain the position information of the corresponding safety stop circuit. The CPU 1A displays the readout text data on the display device 1E (step S111). The CPU 1A reads the current time from an internal clock (step S112) and writes, in the memory M7, the text data read out in step S110 and the current time read in step S112 as an abnormality log (step S113).

The CPU 1A reads out the circuit number of the next break occurrence circuit from the memory M2, reads out text data from an address in the memory M5 corresponding to the circuit number (step S114), and displays the text data on the display device 1E (step S115). The CPU 1A reads the current time from the internal clock (step S116) and writes, in the memory M7, the text data read out in step S114 and the current time read in step S116 as an abnormality log (step S117).

Similarly, the processing operation in steps S114 to S118 is repeated until the processing is ended for all break occurrence circuits in the memory M2 in step S118. With this processing, for all safety stop circuits, i.e., all break occurrence circuits in the memory M2, text data for break occurrence which are predetermined for the circuits are displayed on the display device 1E. In addition, for all break occurrence circuits in the memory M2, the text data and the time when the abnormality has occurred are saved in the memory M7 as an abnormality log.

[Display of Instantaneous Operation Occurrence Circuits and Saving of Abnormality Log]

The CPU 1A reads out the circuit number of the first instantaneous operation occurrence circuit from the memory M3 and reads out text data from an address in the memory M6 corresponding to the circuit number (FIG. 3C: step S119). This text data is text data for instantaneous operation occurrence which is predetermined for the safety stop circuit serving as the first instantaneous operation occurrence circuit. The text data may contain the position information of the corresponding safety stop circuit. The CPU 1A displays the readout text data on the display device 1E (step S120). The CPU 1A reads the current time from the internal clock (step S121) and writes, in the memory M7, the text data read out in step S119 and the current time read in step S121 as an abnormality log (step S122).

The CPU 1A reads out the circuit number of the next instantaneous operation occurrence circuit from the memory M3, reads out text data from an address in the memory M6 corresponding to the circuit number (step S123), and displays the text data on the display device 1E (step S124). The CPU 1A reads the current time from the internal clock (step S125) and writes, in the memory M7, the text data read out in step S123 and the current time read in step S125 as an abnormality log (step S126).

Similarly, the processing operation in steps S123 to S127 is repeated until the processing is ended for all instantaneous operation occurrence circuits in the memory M3 in step S127. With this processing, for all safety stop circuits, i.e., all instantaneous operation occurrence circuits in the memory M3, text data for instantaneous operation occurrence which are predetermined for the circuits are displayed on the display device 1E. In addition, for all instantaneous operation occurrence circuits in the memory M3, the text data and the time when the abnormality has occurred are saved in the memory M7 as an abnormality log.

When the processing for the circuit numbers of all instantaneous operation occurrence circuits in the memory M3 is ended (YES in step S127), the CPU 1A returns to step S101 to initialize the memories M1, M2, and M3 and transmit the detection start signal to the PLC control unit 2 (step S102). The above-described abnormal state detection operation is repeated in the PLC control unit 2. The central control unit 1 receives the “circuit numbers of normal operation occurrence circuits”, the “circuit numbers of break occurrence circuits”, and the “circuit numbers of instantaneous operation occurrence circuits” sent from the PLC control unit 2 and repeats the above-described abnormal state display operation.

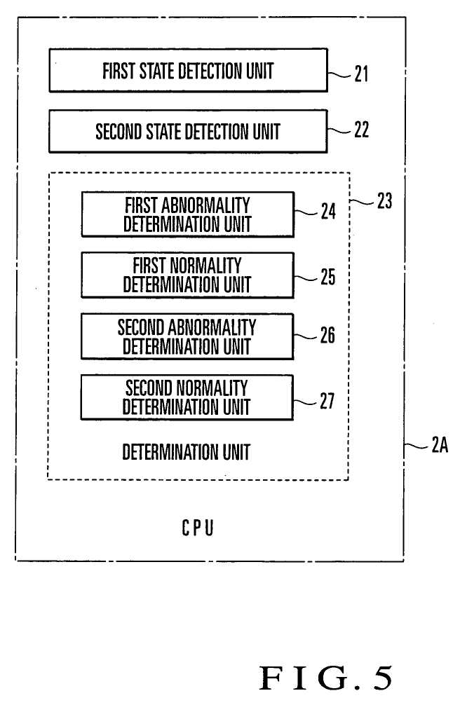

The outline of functions implemented by the CPU 2A of the PLC control unit 2 will be described next with reference to FIG. 5. The CPU 2A operates in accordance with the abnormal state display program stored in the ROM 2C to implement at least a first state detection unit 21, second state detection unit 22, and determination unit 23 shown in FIG. 5.

The first state detection unit 21 detects the state of the A contact SA. More specifically, the first state detection unit 21 executes processing in steps S206, S208, S214, S216, S221, S229, S241, S245, S252, S258, S262, S269, S274, and S291.

The second state detection unit 22 detects the state of the B contact SB. More specifically, the second state detection unit 22 executes processing in steps S204, S212, S223, S225, S231, S233, S239, S256, S276, S280, S287, S293, S297, and S304.

The determination unit 23 determines the normality/abnormality of the A contact SA and B contact SB on the basis of the detection results of the first and second state detection units 21 and 22.

The determination unit 23 includes a first abnormality determination unit 24, first normality determination unit 25, second abnormality determination unit 26, and second normality determination unit 27.

The first abnormality determination unit 24 compares the state of the A contact SA with that of the B contact SB on the basis of the detection results of the first and second state detection units 21 and 22 and, if the two states match, determines that abnormality (break) has occurred. More specifically, the first abnormality determination unit 24 executes processing in steps S210, S218, S227, S235, S254, S271, S289, and S306.

The first normality determination unit 25 compares the state of the A contact SA with that of the B contact SB during stop of the printing press on the basis of the detection results of the first and second state detection units 21 and 22 and, if the two states do not match, determines that the operation is normal (normal operation occurrence). More specifically, the first normality determination unit 25 executes processing in steps S211, S219, S228, and S236.

The second abnormality determination unit 26 determines on the basis of the detection result of at least one of the first and second state detection units 21 and 22 that abnormality has occurred when the target contact returns from the state in the operation to the normal state within a preset time. According to the above-described embodiment, when the first and second state detection units 21 and 22 detect that both the A contact SA and the B contact SB are in the states in the operation during the operation of the printing press, and one of the A contact SA and B contact SB returns from the state in the operation to the normal state within the preset time, the second abnormality determination unit 26 determines that abnormality (instantaneous operation) has occurred. More specifically, the second abnormality determination unit 26 executes processing in steps S247, S264, S282, and S299.

The second normality determination unit 27 determines on the basis of the detection results of the first and second state detection units 21 and 22 that the operation is normal (normal operation occurrence) when both the A contact SA and the B contact SB maintain the states in the operation even beyond the preset time. More specifically, the second normality determination unit 27 executes processing in steps S255, S272, S290, and S307.

As described above, according to this embodiment, the state of the A contact (normally open contact) and the state of the B contact (normally closed contact) are compared. If the two contacts are in the same state, it is determined that abnormality has occurred. More specifically, in the normal state, the A contact and B contact operate complementarily and never have the same state. When the A contact is open, the B contact is closed. When the A contact is closed, the B contact is open. If the A contact and B contact are in the same state, one or both of the A contact and B contact SB are abnormal. In this embodiment, this abnormality is detected by comparing the state of the A contact with that of the B contact. When a plurality of pairs of A contacts and B contacts are present, the state of an A contact and that of a corresponding B contact are compared sequentially, thereby specifying the position of the contact.

Hence, according to this embodiment, when one of contacts of a relay provided in a safety stop circuit of a printing press has broken, the position of the broken contact can be specified so that recovery can be done in a short time. As a result, the decrease in the operating ratio of the printing press can be prevented, and burden for the operator can be reduced.

In this embodiment, occurrence of an instantaneous operation in the A contact or B contact can also be known by monitoring at least one of the states of the A contact and B contact and determining abnormality when the state of the contact returns to the original state within a preset time.

In the above-described embodiment, the A contact (first contact) and B contact (second contact) of a safety stop circuit have been exemplified. However, the first contact and second contact are not limited to the contacts of a relay. The present invention can also be applied to various circuits having contacts that operate in directions reverse to each other (i.e., complementarily) and a device such as a detector having two output lines for outputting signals that operate in directions reverse to each other.

In the above-described embodiment, the states of both the A contact and B contact of the relay of a safety stop circuit are monitored. However, the state of one contact may be monitored, and an instantaneous operation occurrence circuit may be determined when the state of the contact returns to the original state within the preset time.

In the above-described embodiment, the states of the B contact and A contact are compared on the basis of the states of the A contact and B contact of the relay of a safety stop circuit, and occurrence of break is determined. Instead, determination may be done by comparing only one of the states of the B contact and A contact on the basis of only one of the states of the A contact and B contact.

In the above-described embodiment, the abnormality log saved in the memory M7 can be displayed on the display device 1E as needed. If the abnormality log contains not only the abnormality determination result but also the abnormality determination time, the time and type of instantaneous operation that has occurred can be known and used as an aid in repair. In this embodiment, the current time to be saved as the abnormality log is time data containing year, month, and day.

What is claimed is:

1. An abnormal state determination method comprising the steps of:
detecting a state of a first contact that is set to be open normally and closed in an operation;
detecting a state of a second contact that is set to be closed normally and open in the operation complementarily to the first contact; and
comparing the detected state of the first contact with the detected state of the second contact and determining abnormality when the first contact and the second contact are in the same state.

2. A method according to claim 1, further comprising the step of determining abnormality when at least one of the first contact and the second contact returns from the state in the operation to a normal state within a preset time.

3. A method according to claim 1, further comprising the steps of:
determining abnormality when both of the detected first contact and the detected second contact are in the states in the operation, and one of the first contact and the second contact returns from the state in the operation to a normal state within a preset time; and
determining normality when both of the first contact and the second contact maintain the states in the operation even beyond the preset time.

4. A method according to claim 1, wherein in the detecting step, states of contacts of a circuit provided in a printing press are detected as the first contact and the second contact.

5. A method according to claim 1, further comprising the step of storing an abnormality determination result as an abnormality log together with an abnormality determination time.

6. An abnormal state determination apparatus comprising:
first state detection means for detecting a state of a first contact that is set to be open normally and closed in an operation;
second state detection means for detecting a state of a second contact that is set to be closed normally and open in the operation complementarily to the first contact; and
first abnormality determination means for comparing, on the basis of detection results of said first state detection means and said second state state of the second contact and determining abnormality when the first contact and the second contact are in the same state.

7. An apparatus according to claim 6, further comprising second abnormality determination means for determining abnormality on the basis of at least one of detection results of said first state detection means and said second state detection means when a target contact returns from the state in the operation to a normal state within a preset time.

8. An apparatus according to claim 6, further comprising:
second abnormality determination means for determining abnormality when, as a result of detection by said first state detection means and said second state detection means, both of the first contact and the second contact are in the states in the operation, and one of the first contact and the second contact returns from the state in the operation to a normal state within a preset time; and
normality determination means for determining normality when, as the result of detection by said first state detection means and said second state detection means, both of the first contact and the second contact maintain the states in the operation even beyond the preset time.

9. An apparatus according to claim 6, wherein the first contact and the second contact are contacts of a circuit provided in a printing press.

10. An apparatus according to claim 6, further comprising abnormality log storage means for storing a result determined by said first abnormality determination means as abnormality together with an abnormality determination time.
